(19) United States
(12) Patent Application Publication
(10) Pub. No.: US 2005/0248159 A1
(43) Pub. Date: Nov. 10, 2005

(54) System and method for converting potential energy into electrical energy

(76) Inventor: Diego Luis Felipe Bernardo Castanon Seoane, Miraflores (PE)

Correspondence Address: DIEGO,CASTANON SECANE, HONDURAS 330, LIMA 18, PE

(21) Appl. No.: 10/932,159

(22) Filed: Sep. 2, 2004

Related U.S. Application Data
(60) Provisional application No. 60/569,234, filed on May 10, 2004.

(51) Int. Cl. H02P 9/04

(52) U.S. Cl. 290/1 R

(57) ABSTRACT

In a system and method for converting potential energy into electrical energy, a force is applied to a force receiving end of a pendulum arm of a pendulum. The pendulum arm is connected to a periphery of a wheel. The wheel is rotated using the force applied through the pendulum arm and the connection between the pendulum arm and the periphery of the wheel. A rotational force produced by the wheel is then transferred to a generator through a gear mechanism. Electricity is generated by a generator using the rotational force produced by the wheel.

This application claims priority under 35 U.S.C. § 119(e) to U.S. Provisional Application No. 60/569,234, filed on May 10, 2004, the entire content of which is hereby incorporated herein by reference.

### BACKGROUND

1. Field of the Invention

The present invention relates to electrical energy generation. More particularly, the present invention relates to a system and method for converting potential energy into electrical energy.

2. Background Information

Access to reliable and affordable electrical energy has become an indispensable and vital aspect of human development and advancement. Numerous forms of energy production have been harnessed to produce electrical energy, such as, for example, nuclear energy, combustion, geothermal, wind, solar, tidal, biochernistry, hydropower, hydraulic devices and the like. However, many of these types of energy production are inaccessible to remote and/or impoverished areas of the world due to lack of natural resources, wealth, infrastructure, technical expertise and the like. Additionally, remote areas of the world may lack the necessary transportation required to bring to these areas the infrastructure and fuel required to support such power plants.

A number of conventional methods of producing electrical energy also produce environmental pollution as a byproduct. Power plants that utilize combustion to create electrical energy also produce a number of atmospheric pollutants leading to increased greenhouse gases, smog, acid rain and the like. Nuclear facilities produce nuclear waste as a byproduct that is disposed of or stored only with great caution and expense. Pollution is growing concern, not only in industrialized countries, but also in developing areas of the world that lack the ability to institute stringent pollution controls. Other technologies that are more environmentally friendly, such as, for example, wind, solar, tidal power and the like, may not be as reliable as other power plants and may additionally require specialized environmental or geographic conditions that are not available in all areas of the world.

Therefore, there is a need for an apparatus for producing electrical energy that is reliable, affordable and produces no industrial pollution. Additionally, there is a need that the apparatus may be transported and assembled in a number of remote areas inhabited by humans where little or no natural resources are available for fuel. The apparatus should be accessible to individuals with limited technical expertise and be available in a range of sizes so that it can be used in areas that lack abundant space.

### SUMMARY OF THE INVENTION

A system and method are disclosed for converting potential energy into electrical energy. In accordance with exemplary embodiments of the present invention, according to a first aspect of the present invention, a system for converting potential energy into electrical energy includes a wheel. The wheel includes a periphery, a rim, and an axle passing through a center of and substantially perpendicular to the wheel. The axle is attached to a wheel support. The system includes a connecting arm. The connecting arm includes a wheel end and a connector end. The wheel end of the connecting arm is coupled to the periphery of the wheel. The system includes a pendulum arm. The pendulum arm includes a support end, a force receiving end, and a connector portion. The support end is coupled to a pendulum arm support. The connector portion is coupled to the connector end of the connecting arm. The system includes a force producing device. The force producing device is located proximate to and contacts the force receiving end of the pendulum arm. The system also includes a rotational force transferring device. The rotational force transferring device is in contact with the rim of the wheel. The rotational force transferring device is coupled to a generator for generating electricity utilizing a rotational force received from the rotational force transferring device.

According to the first aspect, the system can include a counterweight that can be coupled proximate to the force receiving end of the pendulum arm. The system can include at least one magnet located proximate to the counterweight at a point of a motion of the pendulum arm. The system can include a counterweight that can be located on the periphery of the wheel. The system can include at least one magnet located proximate to the wheel. The system can include a second connecting arm. The second connecting arm can include a wheel end and a connector end. The wheel end of the second connecting arm can be coupled to the periphery of the wheel. The system can include a second pendulum arm. The second pendulum arm can include a support end, a force receiving end, and a connector portion. The support end of the second pendulum arm can be coupled to the pendulum arm support. The connector portion of the second pendulum arm can be coupled to the connector end of the second connecting arm. The system can include a counterweight that can be located on the periphery of the wheel. The system can include a second force producing device. The second force producing device can be located proximate to and contact the force receiving end of the second pendulum arm. The force producing device can be located proximate to and contact the force receiving end of the second pendulum arm. The system can include a first counterweight. The first counterweight can be coupled proximate to the force receiving end of the pendulum arm. The system can also include a second counterweight. The second counterweight can be coupled proximate to the force receiving end of the second pendulum arm.

According to the first aspect, the force receiving end of the pendulum arm can comprise a pad. The force producing device can comprise a piston. Alternatively, the force producing device can comprise a pneumatic piston. The force producing device can be coupled to a control circuit for controlling activation of the force producing device. The rotational force transferring device can comprise a pinion. The rim of the wheel can comprise an interactor structure for engaging the pinion. The interactor structure can comprise a plurality of teeth. The rotational force transferring device can comprise a belt drive for coupling the rotational force transferring device to the generator. A portion of the electricity generated by the generator can be utilized by the force producing device.

According to a second aspect of the present invention, a system for converting potential energy into electrical energy includes a wheel. The wheel includes a periphery, a rim, and an axle passing through a center of and substantially perpendicular to the wheel. The axle is attached to a wheel support. The wheel also includes a force receiving portion. The system includes a counterweight located on the periphery of the wheel. The system includes a force producing device. The force producing device is located proximate to and contacts the force receiving portion of the wheel. The system also includes a rotational force transferring device. The rotational force transferring device is in contact with the rim of the wheel. The rotational force transferring device is coupled to a generator for generating electricity utilizing a rotational force received from the rotational force transferring device.

According to the second aspect, the force producing device can comprise a piston. Alternatively, the force producing device can comprise a pneumatic piston. The force producing device can be coupled to a control circuit for controlling activation of the force producing device. The rotational force transferring device can comprise a pinion. The rim of the wheel can comprise an interactor structure for engaging the pinion. The interactor structure can comprise a plurality of teeth. The rotational force transferring device can comprise a belt drive for coupling the rotational force transferring device to the generator. A portion of the electricity generated by the generator can be utilized by the force producing device.

According to a third aspect of the present invention, a system for converting potential energy into electrical energy includes a pendulum arm. The pendulum arm includes a support end, a force receiving end, and an interactor portion. The support end is coupled to a pendulum arm support. The system includes a wheel. The wheel is oriented substantially perpendicular to the pendulum arm. The wheel includes a periphery, a rim, and an axle passing through a center of and substantially perpendicular to the wheel. The axle is attached to a wheel support. The wheel also includes an interactor structure located on the periphery for engaging the interactor portion of the pendulum arm. The system includes a force producing device. The force producing device is located proximate to and contacts the force receiving end of the pendulum arm. The system also includes a rotational force transferring device. The rotational force transferring device is in contact with the rim of the wheel. The rotational force transferring device is coupled to a generator for generating electricity utilizing a rotational force received from the rotational force transferring device.

According to the third aspect, the system can include a counterweight, that can be coupled proximate to the force receiving end of the pendulum arm. The system can include at least one magnet located proximate to the counterweight at a point of a motion of the pendulum arm. The force receiving end of the pendulum arm can comprise a pad. The force producing device can comprise a piston. Alternatively, the force producing device can comprise a pneumatic piston. The force producing device can be coupled to a control circuit for controlling activation of the force producing device. The rotational force transferring device can comprise a pinion. The rim of the wheel can comprise a plurality of teeth for engaging the pinion. The interactor structure located on the periphery of the wheel can comprise a plurality of teeth. The rotational force transferring device can comprise a belt drive for coupling the force transferring device to the generator. A portion of the electricity generated by the generator is utilized by the force producing device.

According to a fourth aspect of the present invention, a system for converting potential energy into electrical energy includes rotating means for rotating about an axis. The axis is coupled to a first support means for supporting the rotating means. The system includes means for generating rotation of the rotating means. The means for generating rotation comprises a means for receiving force and a connecting means. The means for generating rotation is coupled to a second support means for supporting the means for generating rotation. The system includes coupling means for coupling the connecting means of the means for generating rotation to a periphery of the rotating means. The system includes means for producing force. The means for producing force is located proximate to and contacts the means for receiving force of the means for generating rotation. The system also includes means for transferring rotational force. The means for transferring rotational force is in contact with the rotating means. The means for transferring rotational force is coupled to a means for generating electricity utilizing a rotational force received from the means for transferring rotational force.

According to the fourth aspect, the system can include weighting means for weighting the means for generating rotation, wherein the weighting means can be coupled proximate to the means for receiving force of the means for generating rotation. The system can include at least one magnet means located proximate to the weighting means at a point of a motion of the means for generating rotation. The system can include weighting means for weighting the rotating means, wherein the weighting means can be located on the periphery of the rotating means. The system can include at least one magnet means located proximate to the rotating means. The system can include a second means for generating rotation of the rotating means. The second means for generating rotation can comprise a means for receiving force and a connecting means. The means for generating rotation can be coupled to the second support means for supporting the second means for generating rotation. The system can include a second coupling means for coupling the connecting means of the second means for generating rotation to the periphery of the rotating means. The system can include weighting means for weighting the rotating means, wherein the weighting means can be located on the periphery of the rotating means. The system can include a second means for producing force. The second means for producing force can be located proximate to and contact the means for receiving force of the second means for generating rotation. The means for producing force can be located proximate to and contacts the means for receiving force of the second means for generating rotation. The system can include a first weighting means for weighting the means for generating rotation. The first weighting means can be coupled proximate to the means for receiving force of the means for generating rotation. The system can also include a second weighting means for weighting the second means for generating rotation. The second weighting means can be coupled proximate to the means for receiving force of the second means for generating rotation.

According to the fourth aspect, the means for receiving force of the means for generating rotation can comprise a pad means. The means for producing force can comprise a piston means. The means for producing force can comprise a pneumatic piston means. The means for producing force can be coupled to a means for controlling activation of the means for producing force. The means for transferring rotational force can comprise a pinion means. The rotating means can comprise means for engaging the pinion means. The means for engaging the pinion means can comprise a plurality of teeth means. The means for transferring rotational force can comprise a means for coupling the means for transferring rotational force to the means for generating electricity. A portion of the electricity generated by the means for generating electricity can be utilized by the means for producing force.

According to a fifth aspect of the present invention, a system for converting potential energy into electrical energy includes rotating means for rotating about an axis. The rotating means includes a means for receiving force. The axis is coupled to a first support means for supporting the rotating means. The system includes weighting means for weighting the rotating means. The weighting means is located on a periphery of the rotating means. The system includes means for producing force. The means for producing force is located proximate to and contacts the means for receiving force of the rotating means. The system also includes means for transferring rotational force. The means for transferring rotational force is in contact with the rotating means. The means for transferring rotational force is coupled to a means for generating electricity utilizing a rotational force received from the means for transferring rotational force.

According to the fifth aspect, the means for producing force can comprise a piston means. Alternatively, the means for producing force can comprise a pneumatic piston means. The means for producing force can be coupled to a means for controlling activation of the means for producing force. The means for transferring force can comprise a pinion means. The rotating means can comprise a means for engaging the pinion means. The means for engaging can comprise a plurality of teeth means. The means for transferring rotational force can comprise a means for coupling the means for transferring rotational force to the means for generating electricity. A portion of the electricity generated by the means for generating electricity can be utilized by the means for producing force.

According to a sixth aspect of the present invention, a system for converting potential energy into electrical energy includes means for generating rotation. The means for generating rotation includes a means for engaging and a means for receiving force. The means for generating is coupled to a first support means for supporting the means for generating rotation. The system includes rotating means for rotating about an axis. The rotating means is oriented substantially perpendicular to the means for generating rotation. The rotating means includes interactor means located on a periphery of the rotating means for engaging the means for engaging of the means for generating rotation. The axis is coupled to a second support means for supporting the rotating means. The system includes means for producing force. The means for producing force is located proximate to and contacts the means for receiving force of the means for generating rotation. The system also includes means for transferring rotational force. The means for transferring rotational force is in contact with the rotating means. The means for transferring rotational force is coupled to a means for generating electricity utilizing a rotational force received from the means for transferring rotational force.

According to the sixth aspect, the system can include weighting means for weighting the means for generating rotation. The weighting means can be coupled proximate to the means for receiving force of the means for generating rotation. The system can include at least one magnet means located proximate to the weighting means at a point of a motion of the means for generating rotation. The means for receiving force of the means for generating rotation can comprise a pad means. The means for producing force can comprise a piston means. Alternatively, the means for producing force can comprise a pneumatic piston means. The means for producing force can be coupled to a means for controlling activation of the means for producing force. The means for transferring rotational force can comprise a pinion means. The rotating means can comprise a plurality of means for engaging the pinion. The interactor means can be located on the periphery of the rotating means comprises a plurality of teeth means. The means for transferring rotational force can comprise a means for coupling the means for transferring rotational force to the means for generating electricity. A portion of the electricity generated by the means for generating electricity can be utilized by the means for producing force.

According to a seventh aspect of the present invention, a system for converting potential energy into electrical energy includes rotatable means for generating a rotational force. The system includes means for rotating the rotatable means. The means for rotating is coupled to the rotatable means. The means for rotating is configured to receive a force produced by a means for producing the force and to utilize the force to rotate the rotatable means. The system includes means for transferring the rotational force in contact with the means for generating the rotational force. The system also includes means for generating electricity coupled to the means for transferring the rotational force. The means for generating electricity utilizes the rotational force received from the means for transferring the rotational force to generate electricity.

According to an eighth aspect of the present invention, an apparatus for converting potential energy into electrical energy includes a wheel comprising a periphery, a rim, and a center. The center comprises an opening. The system includes an axle passing through the center of the wheel. The wheel is oriented substantially vertically around the axle. The system includes a counterweight located on the periphery of the wheel. The system includes means for receiving force. The means for receiving force is located on the periphery of the wheel. The system includes means for applying force. The means for applying force is located proximate to the means for receiving force. The means for applying force contacts the means for receiving force. The system also includes means for transferring rotational force. The means for transferring rotational force contacts the rim of the wheel. The means for transferring rotational force is coupled to a means for generating electricity utilizing a rotational force received from the means for transferring rotational force.

According to a ninth aspect of the present invention, a method of converting potential energy into electrical energy includes the steps of: a.) applying a force to a force receiving end of a pendulum arm of a pendulum, wherein the pendulum arm is connected to a periphery of a wheel; b.) rotating the wheel using the force applied through the pendulum arm and the connection between the pendulum arm and the periphery of the wheel; c.) transferring a rotational force produced by the wheel to a generator; and d.) generating electricity by the generator using the rotational force produced by the wheel.

According to the ninth aspect, the method can include the steps of: e.) weighting the pendulum arm with a counterweight, wherein the counterweight is coupled proximate to the force receiving end of the pendulum arm; f.) locating at least one magnet proximate to the counterweight at a point of a motion of the pendulum arm; g.) weighting the wheel with a counterweight, wherein the counterweight is located on the periphery of the wheel; h.) locating at least one magnet proximate to the wheel; i.) applying a second force to a force receiving end of a second pendulum arm of the pendulum, wherein the second pendulum arm is connected to a periphery of a wheel; j.) rotating the wheel using the second force applied through the second pendulum arm and the connection between the second pendulum arm and the periphery of the wheel; k.) weighting the wheel with a counterweight, wherein the counterweight is located on the periphery of the wheel; l.) weighting the pendulum arm with a first counterweight, wherein the first counterweight is coupled proximate to the force receiving end of the pendulum arm; m.) weighting the second pendulum arm with a second counterweight, wherein the second counterweight is coupled proximate to the force receiving end of the second pendulum arm; n.) controlling application of the force to the pendulum arm, wherein the force is applied to the pendulum arm at predetermined intervals; and o.) feeding a portion of the electricity generated by the generator to the step of applying the force.

According to a tenth aspect of the present invention, a method of converting potential energy into electrical energy, comprising the steps of: a.) applying a force to a force receiving portion of a wheel; b.) rotating the wheel using the force applied to the force receiving portion of the wheel; c.) transferring a rotational force produced by the wheel to a generator; and d.) generating electricity by the generator using the rotational force produced by the wheel.

According to the tenth aspect, the step of applying can comprise the step of: e.) controlling application of the force to the wheel, wherein the force is applied to the wheel at predetermined intervals. The method can include the step of: f.) feeding a portion of the electricity generated by the generator to the step of applying the force.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a diagram illustrating a system for converting potential energy into electrical energy, in accordance with an exemplary embodiment of the present invention.

FIG. 2 is a diagram illustrating a system for converting potential energy into electrical energy, in accordance with an alternative exemplary embodiment of the present invention.

FIG. 3 is a diagram illustrating a side view of a system for converting potential energy into electrical energy, in accordance with an exemplary embodiment of the present invention.

FIGS. 4A and 4B are diagrams illustrating side and overhead views of a system for converting potential energy into electrical energy, in accordance with an exemplary embodiment of the present invention.

FIG. 5 is a diagram illustrating an overhead view of the system illustrated in FIG. 2 for converting potential energy into electrical energy, in accordance with an exemplary embodiment of the present invention.

FIG. 6 is a diagram illustrating a system for converting potential energy into electrical energy, in accordance with an alternative exemplary embodiment of the present invention.

FIG. 7 is a flowchart illustrating steps for converting potential energy into electrical energy, in accordance with an exemplary embodiment of the present invention.

FIG. 8 is a flowchart illustrating steps for converting potential energy into electrical energy, in accordance with an alternative exemplary embodiment of the present invention.

### DETAILED DESCRIPTION OF THE PREFERRED EMBODIMENTS

Exemplary embodiments of the present invention are directed to a system and method for converting potential energy into electrical energy. According to exemplary embodiments, a wheel includes a periphery, a rim and a center, with an axle passing through the center of the wheel. The wheel is oriented substantially vertically around the axle. The wheel includes teeth or other engaging mechanism around the rim that engage a gear or the like. The gear is connected to an electrical generator. A pendulum arm is connected to the periphery of the wheel using a connector arm. A counterweight can be located either on the periphery of the wheel or on the end of the pendulum arm. A piston or other force producing device moves the pendulum arm so as to rotate the wheel. For example, if the counterweight is located on the periphery of the wheel, the wheel is rotated so that the counterweight reaches a maximum height. The wheel is then released so that the counterweight descends from the maximum height to the minimum height. If the counterweight is located on the pendulum arm, the swing of the (weighted) pendulum arm rotates the wheel. Before the counterweight reaches the minimum height (if the counterweight is attached to the wheel periphery) or before the counterweight reaches the apex of the pendulum swing (if the counterweight is attached to the pendulum arm), the piston or other force producing device applies a force to the pendulum arm, impelling the wheel along its rotational motion. The rotational energy of the wheel can then be transferred to the electrical generator through the gear to generate electrical energy. A portion of the electrical energy generated by the electrical generator can be fed back to the piston or other force producing device to power the device to continue rotation of the wheel and electricity generation.

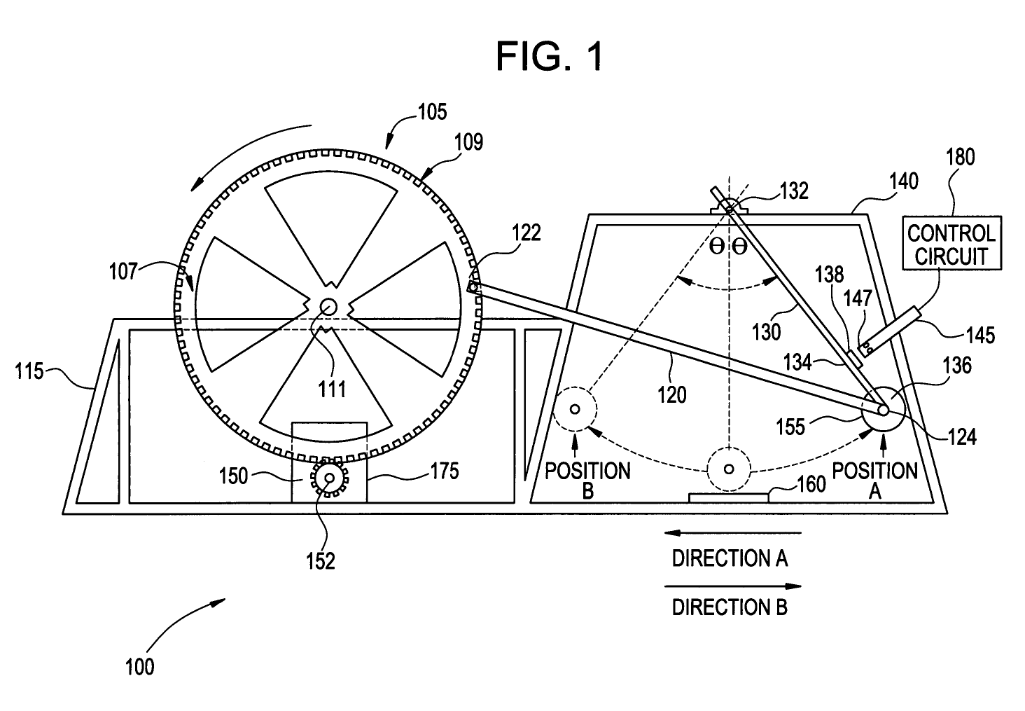

These and other aspects of the present invention will now be described in greater detail. FIG. 1 is a diagram illustrating a system 100 for converting potential energy into electrical energy, in accordance with an exemplary embodiment of the present invention. The system 100 includes a wheel 105. The wheel 105 includes a periphery 107, a rim 109, and an axle 111, passing through the center of and substantially perpendicular to the wheel 105, around which the wheel 105 can rotate. The axle 111 can be attached to a wheel support 115 to provide a mount for the wheel 105. The system 100 includes a connecting arm 120. The connecting arm 120 can include a wheel end 122 and a connecter end 124. The wheel end 122 of the connecting arm 120 can be coupled or otherwise connected to the periphery 107 of the wheel 105.

The system 100 includes a pendulum arm 130. The pendulum arm 130 includes a support end 132, a force receiving end 134 and a connector portion 136. The support end 132 can be coupled to a pendulum arm support 140 to provide a mount for the pendulum arm 130. The connector portion 136 can be coupled to the connector end 124 of the connecting arm 120. The system 100 includes a force producing device 145. The force producing device 145 is located proximate to and contacts the force receiving end 134 of the pendulum arm 130. The system also includes a rotational force transferring device 150. The rotational force transferring device 150 is in contract with the rim 109 of the wheel 105. The rotational force transferring device 150 is coupled to a generator 175 for generating electricity utilizing a rotational force received from the rotational force transferring device 150 in a known manner. The system 100 includes a counterweight 155. According to the exemplary embodiment illustrated in FIG. 1, the counterweight 155 is coupled proximate to the force receiving end 134 of the pendulum arm 130.

According to exemplary embodiments, when the pendulum arm 130 is in Position A at an apex of its swing, the force producing device 145 applies a suitable force to the force producing end 134 of the pendulum arm 130. The application of force causes the pendulum arm 130 to swing in Direction A. The movement of pendulum arm 130 as it swings in Direction A is transferred to wheel 105 through connecting arm 120, causing the wheel 105 to rotate counterclockwise in the illustration (although the wheel 105 can rotate either clockwise or counterclockwise). As the wheel 105 rotates, the rotational force of the wheel 105 is transferred to rotational force transferring device 150. As the wheel 105 turns the rotational force transferring device 150, the rotational force transferring device 150 thereby turns the generator 175 to generate electricity. After the pendulum arm 130 reaches the opposing apex of its swing at Position B, the pendulum arm 130 then swings in the opposite direction (Direction B) back toward Position A. The movement of pendulum arm 130 as it swings in Direction B is transferred to wheel 105 through connecting arm 120, causing the wheel 105 to continue to rotate counterclockwise in the illustration, which further turns the rotational force transferring device 150. Once the pendulum arm 130 reaches its apex at Position A, the force producing device 145 again applies a suitable force to the force producing end 134 of the pendulum arm 130. Thus, the swinging motion of pendulum arm 130 and the rotation of wheel 105 can be maintained, thereby providing a substantially continuous generation of electricity by the generator 175 by the transference of the rotational force to the generator 175 through the wheel 105 and rotational force transferring device 150.

According to exemplary embodiments, the wheel 105 can be constructed of any suitably durable substance, such as, for example, metal, wood, plastic or the like. The diameter and weight of the wheel 105 will vary, depending on factors such as, for example, the available space of the area of installation of system 100, the size of the counterweight 155, the desired amount of energy production, and the like. For example, the diameter of the wheel 105 can be in the range of approximately one meter to approximately ten meters, with the diameter of the wheel 105 being approximately two meters in a preferred embodiment. However, the wheel 105 can be any suitable diameter. The axle 111 can be formed from any suitably durable substance, such as, for example, metal, wood, plastic or the like. For example, the axle 111 can be formed of a high-torsion steel alloy or the like. The diameter and length of the axle 111 will depend on the size of the wheel 105. For example, the diameter of the axle 111 can be in the range of approximately forty millimeters to approximately one hundred millimeters, with the diameter of the axle 111 being approximately sixty two millimeters in a preferred embodiment. However, the axle 111 can be of any suitable diameter.

The counterweight 155 can be separately attached to the pendulum arm 130 or can be integrally formed with the pendulum arm 130. For example, the pendulum arm 130 can include elements for attaching counterweight 155, such as, for example, pins or protrusions for mounting the counterweight 155, where the counterweight 155 would include complimentary holes or slots for engaging the pins or protrusions. The size and shape of the counterweight 155 can vary, depending on, for example, the size of the wheel 105, and the like. According to exemplary embodiments, the counterweight 155 can be shaped to reduce air friction as it swings with pendulum arm 130. The weight of the counterweight 155 can vary, depending on, for example, the structure and diameter of the wheel 105, the amount of electrical energy to be produced by the generator 175, the amount of rotational force produced by the wheel 105 that is needed to turn rotational force transferring device 150 to turn the generator 175, and the like. For example, the weight of the counterweight 155 can be in the range of approximately zero kilograms to approximately five hundred kilograms, with the weight of the counterweight 155 being in the range of approximately forty kilograms to approximately two hundred kilograms in a preferred embodiment. However, the counterweight 155 can be of any suitable weight. In addition, any appropriate number of counterweights 155 can be located on pendulum arm 130. For example, a plurality of counterweights 155 can be stacked on each other and attached to the pendulum arm 130. The counterweights 155 can be located, for example, on one or more sides of the pendulum arm 130. For example, according to one exemplary embodiment of the present invention, the pendulum arm 130 includes two counterweights 155, one located on each side of the pendulum arm 130, where each counterweight 155 weighs in the range of approximately forty kilograms to approximately two hundred kilograms.

The wheel 105 can include a fastener or an opening for attaching the wheel end 122 of the connecting arm 120 to the periphery 107 of the wheel 105. The connecting arm 120 would then have a complementary attachment on the wheel end 122 that corresponds to the fastener or opening on the wheel 105 to facilitate attachment to the wheel 105. For example, both the wheel 105 and connecting arm 120 can include an opening through which a pin or like connector can be placed. According to an exemplary embodiment, the wheel end 122 of the connecting arm 120 can include an opening through which the pin or like connector can be placed. Consequently, the periphery 107 of the wheel 105 can include an opening complementary to the opening in the wheel end 122 of the connecting arm 120 through which the pin or like connector can be inserted to attach the connecting arm 120 to the wheel 105. The length of the connecting arm 120 can vary, depending on, for example, the diameter of the wheel 105, the distance the wheel 105 is located from the pendulum arm 120, and the like. For example, the length of the connecting arm 120 can be approximately three meters, although the connecting arm 120 can be of any suitable length.

The pendulum arm 130 can vary in length and weight depending on the requirements of the system 100 for energy production. For example, the length of the pendulum arm 130 can depend on the size (diameter) of the wheel 105, the pendulum arm support 140, the location of the force producing device 145, and the like. The pendulum arm support 140 can also vary in height depending on the length of the pendulum arm 130. The pendulum arm 130 can be attached to the pendulum arm support 140 by, for example, a pin or like connector located on the support end 132. The pin can allow the pendulum arm 130 to swing at a predetermined distance. The swing distance of the pendulum arm 130 can depend on, for example, the length of the pendulum arm 130, the height of the pendulum arm support 140, the length of the connecting arm 120, the location of the force producing device 145, and the like. For example, the pendulum arm 130 can swing approximately Θ=45° in each direction from the nadir of the swing movement of pendulum arm 130, although the pendulum arm 130 can swing any suitable degree Θ in each direction.

According to an exemplary embodiment, the pendulum arm 130 can include a slot or like opening in connector portion 136 that is sized to accept the connector end 124 of the connecting arm 120. The connector end 124 of the connecting arm 120 can include a slot or like opening that can correspond to the size of the slot in the connector portion 136 of the pendulum arm 130. According to an exemplary embodiment, a sliding pin or like connector can be placed through the slots or like opening in the connector portion 136 and connector end 124 to attach the connecting arm 120 to the pendulum arm 130. The sliding pin or like connector can move up and down the slot or like opening in connector portion 136 as the pendulum arm 130 swings on pendulum arm support 140.

According to exemplary embodiments, the force receiving end 134 of the pendulum arm 130 can be configured to receive a force or impact from the force producing device 145. The force receiving end 134 can be further reinforced to receive an impact by adding reinforcing material to the pendulum arm 130. Additionally or alternatively, the force receiving end 134 can include a specialized force receiving structure 138, such as, for example, a pad, indentation, spring, shield, or the like, or any combination thereof. For example, an indention can be shaped to receive the pendulum impacting end 147 of the force producing device 145.

According to exemplary embodiments, the pendulum arm support 140 can be located at a predetermined distance from the center of the wheel 105 and the force producing device 130. The distance between the pendulum arm support 140 and the wheel 105 will depend on, for example, the diameter of the wheel 105, the length of the connecting arm 120, the length of the pendulum arm 130, and the like. According to an exemplary embodiment, the distance between a center vertical axis of the pendulum arm support 140 and the center of the wheel 105 can be smaller than the length of the connecting arm 120. For example, the pendulum arm support 140 can be located approximately 2.6 meters from the center of the wheel 105, in a preferred embodiment, although the pendulum arm support 140 can be located any suitable distance from the center of the wheel 105.

According to exemplary embodiments, the force producing device 145 can be mounted on the pendulum arm support 140 using any suitable means for mounting the device. Alternatively, the force producing device 145 can be mounted on a separate support. The pendulum impacting end 147 of the force producing device 145 can physically contact the force receiving end 134 of the pendulum arm 130. The force producing device 145 may be any suitable mechanism or device that can produce a force of a predetermined amount. As discussed previously, the force provided by the force producing device 145 is applied to push the pendulum arm 130. According to exemplary embodiments, the force producing device 145 can include, for example, a piston, a spring actuated device, a water jet, an air compressor, a magnet, a wheel, a pulley, a gear, or the like. For example, the force producing device 145 can be is a pneumatic piston in a preferred embodiment, although the force producing device 145 can be any suitable means for producing a force of a predetermined amount.

According to an exemplary embodiment, the force producing device 145 can be coupled to a control circuit 180 for controlling activation of the force producing device 145. Based on, for example, the rate of swing of the pendulum arm 130, the control circuit 180 can control the timing of the activation of the pendulum impacting end 147 of the force producing device 145 to coincide with the time when the pendulum arm 130 is at Position A illustrated in FIG. 1 (i.e., at an apex of the swing arc) to maximize the amount of force applied to the force receiving end 134 of the pendulum arm 130. The control circuit 180 can be comprised of any suitable digital, analog, or mechanical means that is capable of consistently and reliably activating the force producing device 145 at predetermined times or intervals.

According to exemplary embodiments, the rotational force transferring device 150 can be any suitable means for transferring the rotational force of the wheel 105 to the electrical generator 175. For example, the rotation force transferring device 150 can include a pinion, a wheel, a gear or the like. According to an exemplary embodiment, the rotational force transferring device 150 can include a belt drive for coupling the rotational force transferring device 150 to the generator 175. The rotational force transferring device 150 can be comprised of any suitably durable material, so that the device can withstand constant turning, such as, for example, metal, plastic and the like. According to an exemplary embodiment, the rotational force transferring device 150 can include a metal device coated in rubber or a rubber device. The rotational force transferring device 150 can be attached to the electrical generator 175 by an axle 152. According to exemplary embodiments, the rim 109 of the wheel 105 can comprise an interactor structure for engaging the rotational force transferring device 150. The interactor structure can be any suitable structure or element for interacting with or otherwise engaging the rotational force transferring device 150. For example, the rotational force transferring device 150 can comprise a pinion or gear system and the interactor structure along the rim 109 of the wheel 105 can comprise a plurality of teeth. Alternatively, if the rotational force transferring device 150 comprises rubber or a rubber device, the rim 109 of the wheel 105 can be comprised of rubber or the like to engage the rubber of the rotational force transferring device 150. Other suitable interacting structures to allow the rim 109 of the wheel 105 to engage the rotational force transferring device 150 are possible.

As discussed previously, a portion of the electricity generated by the generator 175 can be utilized by the force producing device 145 to power the device. Thus, according to exemplary embodiments, the force producing device 145 can be electrically coupled to the generator 175 using any suitable means for transferring electricity, such as a wire, cable, or the like. The remaining electricity produced by generator 175 can then be used for any suitable device or purpose that requires electricity to function. Alternatively, the electricity for operating the force producing device 145 can be supplied from a power source separate from generator 175. For example, the force producing device 145 can be electrically connected to a wall or electrical outlet or other power grid, thereby allowing the system 100 to produce electricity in addition to that supplied to the area by other means (such as another power grid). The generator 175 can be any suitable type of generator capable of producing electricity through application of a rotational force (e.g., torque). For example, the generator 175 can be a low-torque, low-RPM model for generating electricity with improved efficiency, or a higher-torque, higher-RPM model for providing greater amounts of electricity. The generator 175 can be of any suitable electrical generation capacity (e.g., watt, kilowatt or megawatt) to produce any desired amount of electricity, depending on the needs for which the system 100 will be applied. As discussed previously, the size, shape and weight of the other components of system 100 will depend, for example, on the amount of rotational force (e.g., torque) needed to turn the generator 175 to produce the desired amount of electricity.

According to exemplary embodiments, the system 100 can include additional means for exerting force on the pendulum arm 130 to maintain the swinging motion of the pendulum arm 130. For example, at least one magnet 160 can be located proximate to the counterweight 155 at a point of the motion of the pendulum arm 130 (e.g., if either or both of the pendulum arm 130 and counterweight 155 are comprised in whole or in part of metal). The at least one magnet 160 can be positioned anywhere along the swing arc of the pendulum arm 130. However, according to exemplary embodiments, the at least one magnet 160 can be located at the point in the swing arc of the pendulum arm 130 that will provide the most additional force to the pendulum arm 130, such as at the nadir of the swing arc.

Alternatively, a plurality of magnets 160 can be used in the form of a track, for example, in parallel with the swing arc of the pendulum arm 130. For example, a magnet can be positioned on the pendulum arm 130 proximate to the connector portion 136 of the pendulum arm 130. As the pendulum arm 130 swings, each of the magnets 160 can be turned on in succession to repel the magnet positioned on the pendulum arm 130, thereby providing additional force to the pendulum arm 130. Alternatively or additionally to the use of force producing device 145, a magnet can be located proximate to the apex of the swing arc of the pendulum arm 130, such as at either or both of Positions A and B. With a magnet attached to the pendulum arm 130, as the pendulum arm 130 reaches the apex of its swing at either Position A or B, the magnet located proximate to the given (apex) position can be turned on to repel the magnet positioned on the pendulum arm 130, thereby providing additional or alternative force to the pendulum arm 130. By providing at least one magnet 160 or other suitable additional force producing means, the amount of force applied by the force producing device 145 can be reduced, thereby reducing the size and power requirements of the force producing device 145. According to an exemplary embodiment, the at least one magnet 160 can be comprised of neodymium rare earth magnets.

Other alternative configurations of the system 100 illustrated in FIG. 1 are possible. For example, the system 100 can include a second connecting arm, also comprising a wheel end and a connector end. The wheel end of the second connecting arm can be coupled to the periphery 107 of the wheel 105 on a side opposite to that of connecting arm 120. The system 100 can include a second pendulum arm, also comprising a support end, a force receiving end, and a connector portion. The support end of the second pendulum arm can be coupled to the pendulum arm support 140. The connector portion of the second pendulum arm can be coupled to the connector end of the second connecting arm. The system 100 can include a second force producing device located proximate to and contacts the force receiving end of the second pendulum arm. Alternatively, the force producing device 145 can be located proximate to and contact the force receiving end of the second pendulum arm, thereby providing force to both the pendulum arm 130 and the second pendulum arm. According to either embodiment, a second counterweight can be coupled proximate to the force receiving end of the second pendulum arm. Thus, forces can be applied to the pendulum arm 130 and the second pendulum arm (using either a single or dual force producing devices 145) so that the pendulum arms can either swing in unison or in opposition (i.e., when pendulum arm 130 is at Position A, the second pendulum arm is at Position B, and vice versa) to turn wheel 105 to provide addition rotational force to the rotational force transferring device 150. Other configurations are possible. For example, one or more force producing devices 145 can be located at each apex of the swing arc of the pendulum 130, such as at both Position A and Position B, to provide additional force to the pendulum arm 130.

For example, according to an alternative exemplary embodiment, the wheel 105 can be oriented substantially perpendicular to the pendulum arm 130, for example, above the pendulum arm support 140. The pendulum arm 130 can include an interactor portion, for example, near the support end 132 of the pendulum arm 130. The wheel 105 can include an interactor structure, such as, for example, a plurality of teeth, located on the periphery 107 of the wheel 105 for engaging the interactor portion of the pendulum arm 130. For example, the interactor structure can be substantially perpendicular to the plane of the wheel 105 to engage the interactor portion of the pendulum arm 130. According to the alternative exemplary embodiment, as the pendulum arm 130 swings, the interactor portion engages the interactor structure of the wheel 105 in the form of a ratchet mechanism or the like to rotate the wheel 105. The rotational force of the wheel 105 is then transferred to the generator 175 using the rotational force transferring device 150 in the manner described herein. Alternatively, one end of a connecting arm can be connected to the support end 132 of the pendulum arm 130, and the other end of the connecting arm can be connected to the substantially perpendicularly-oriented wheel 105 (e.g., to the interactor structure or nearer to the center of the wheel 105). Thus, as the pendulum arm 130 swings, the connecting arm connected to the support end of the pendulum arm 130 can transfer force through the connecting arm to rotate to the substantially perpendicularly-oriented wheel 105. The substantially perpendicularly-oriented wheel 105 can then transfer rotational force to a rotational force transferring device to turn a generator. Other configurations of the system 100 are possible.

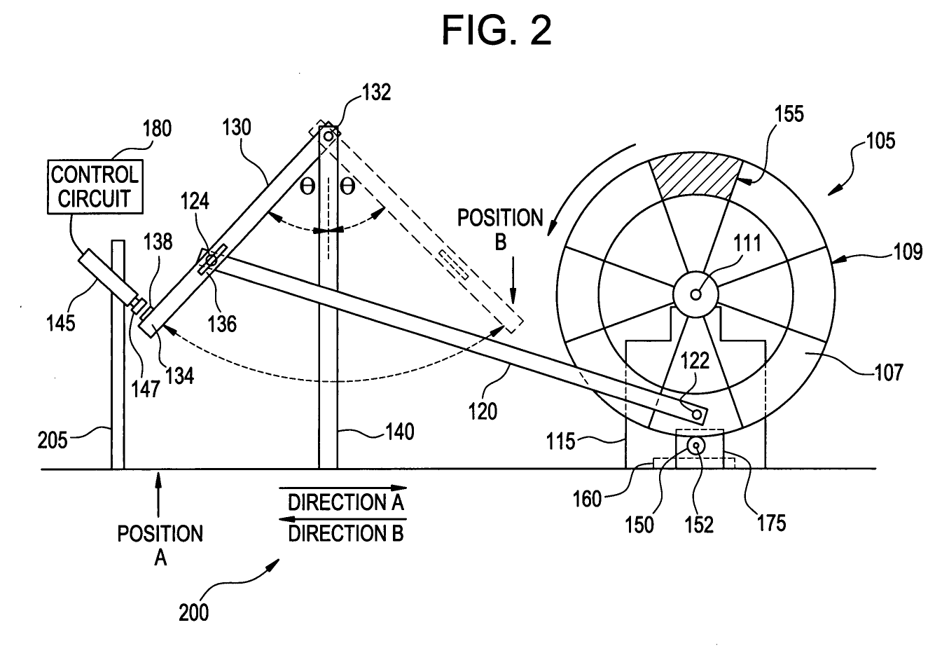

Alternatively, for example, FIG. 2 is a diagram illustrating a system 200 for converting potential energy into electrical energy, in accordance with an alternative exemplary embodiment of the present invention. The system 200 includes the counterweight 155 located in the periphery 107 or outer diameter of the wheel 105 (additionally, a separate support structure 205 can be used to support the force producing device 145). The counterweight 155 rotates from a maximum height to a minimum height, using the force applied by force producing device 145 to the pendulum arm 130 through the connecting arm 120. The counterweight 155 can be separately attached or otherwise connected to the wheel 105 or can be integrally formed with the wheel 105. At least one magnet 160 can be located proximate to the wheel 105 to assist in providing force to turn the wheel 105 (e.g., if the counterweight is composed in whole or in part of metal). As with the embodiment illustrated in FIG. 1, multiple pendulum arms 130, multiple connecting arms 120 and multiple force producing devices 145 can be used to exert additional force to turn the wheel 105 and, in turn, the rotational force transferring device 150 and generator 175. A counterweight can be attached to the pendulum arm(s) 130, in addition to the counterweight 155 located in the periphery 107 of the wheel 105, to provide additional force to the wheel 105.

For purposes of illustration and not limitation, according to an exemplary embodiment of the present invention illustrated in FIG. 2, the wheel 105 can be 1.99 m in diameter. The axle 111 can be 62 mm in diameter. The wheel support 115 can be 1.325 m high. The connecting arm 120 can be a one inch wide (solid) pipe of steel or the like and 2.756 m long. The pendulum arm 130 can be 2.0 m long, and the height of the pendulum arm support 140 can be 2.41 m. The length from the (vertical) center plane of the pendulum arm support 140 to the (vertical) center plane of the wheel 105 can be 2.625 m. The counterweight 155 can weight 1200 kg (using either single or multiple counterweights 155). The rim 109 of the wheel 105 can have dents with pitch six, while the outer diameter of the rotational force transferring device 150 can also have dents with pitch six to engage the corresponding dents in the rim 109 of the wheel 105. In such a configuration, a suitable low-torque, low-RPM (e.g., 600 RPM), three horsepower generator 175 can generate between approximately three and five kilowatts. Alternatively, a suitable higher-torque, higher-RPM (e.g., 1800 RPM), ten horsepower generator 175 can generate between approximately five and nine kilowatts. Other configurations of the components of systems 100 and 200 are possible, depending on, for example, the desired amount of electricity generation.

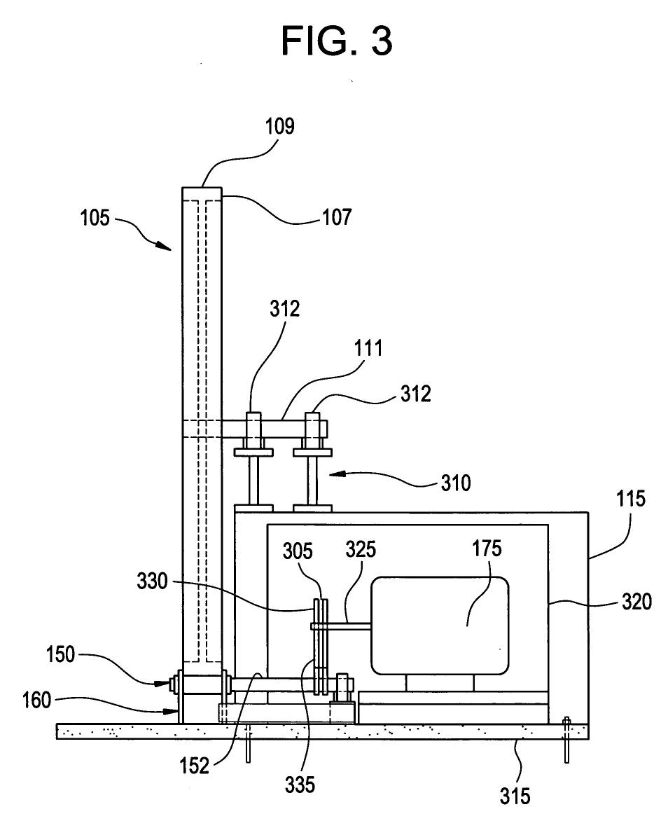

FIG. 3 is a diagram illustrating a side view of the system (100 or 200) for converting potential energy into electrical energy, in accordance with an exemplary embodiment of the present invention. In particular, FIG. 3 illustrates a side view of the wheel 105 (including the periphery 107 and rim 109) and the axle 111, as well as the rotational force transferring device 150 and axle 152. The axle 111 can attach the wheel 105 to a mounting structure 310. The mounting structure 310 can include mounting elements 312 for inserting the axle 111. The mounting elements 312 can be configured to allow for the unencumbered rotation of the axle 111. The mounting structure 310 can be attached to the wheel support 115. The wheel support 115 can be mounted to a base 315. In accordance with the embodiment illustrated in FIG. 2, the wheel support 115 can also include at least one magnet 160 oriented to further impel the rotation of the wheel 105 and the counterweight 155 as the counterweight 155 descends towards the minimum height.

A housing element 320 can form a part of the generator 175, where the housing element 320 houses the generator 175. The generator 175 receives rotational force from the wheel 105 through the rotational force transferring device 150. According to an exemplary embodiment, the rotational force transferring device 150 comprises a pinion that rotates the axle 152. The axle 152 enters into the housing element 320 of the generator 175, where the axle 152 is attached to a mechanism to transfer the rotational force from the axle 152 to the generator 175. According to an exemplary embodiment, the mechanism can comprise a pulley/belt system 305. The pulley/belt system 305 includes an axle wheel 325, a pulley wheel 330 and a belt 335. The belt 335 can be looped around the axle wheel 325 and the pulley wheel 330. The axle 152 is attached to the axle wheel 325. The axle wheel 325 can engage the belt 335 that engages the pulley wheel 330. The pulley wheel 330 turns axle 325 that activates the generator 275. However, the mechanism can be any suitable means for transferring, such as, for example, a gear system. The generator 175 can further include wires, cables or other electrical connections for transporting the electrical energy away from the system for use in residential, commercial, industrial, educational and/or other like applications. The generator 175 can also include a wire, cable and/or other electrical connection to the force producing device 145 to provide electrical energy to the force producing device 145.

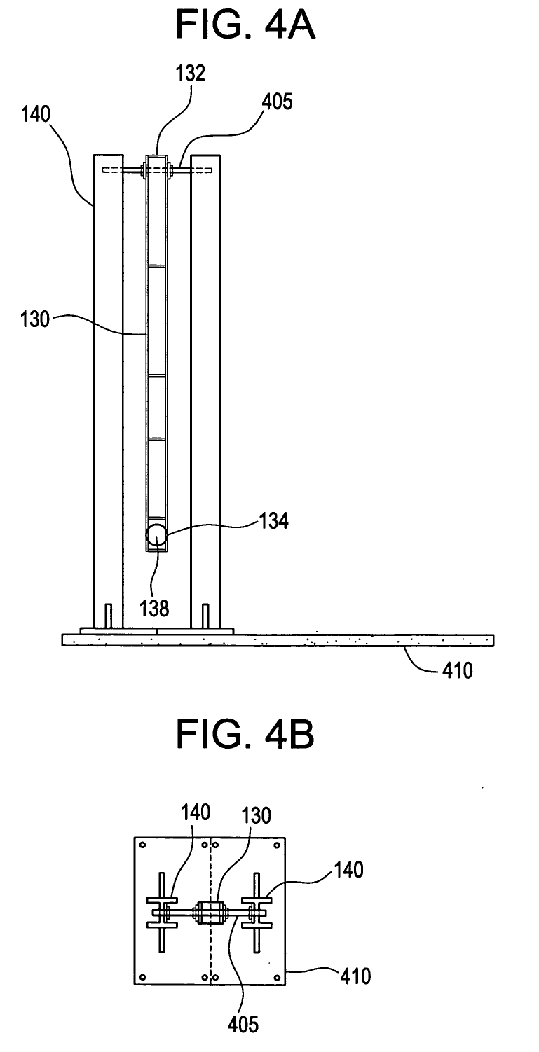

FIGS. 4A and 4B are diagrams illustrating side and overhead views of the system (100 or 200) for converting potential energy into electrical energy, in accordance with an exemplary embodiment of the present invention. In particular, FIG. 4A illustrates a side view of the pendulum arm 130. The pendulum arm 130 includes the support end 132 and the force receiving end 134. The support end 132 can include a pin 405 or the like that can attach the pendulum arm 130 to the pendulum arm support 140. The force receiving end 134 includes force receiving structure 138. The pendulum arm support 140 can be mounted to a base 410. FIG. 4B illustrates an overhead view of the pendulum arm 130. The pendulum arm 130 can be attached to the pendulum arm support 140 using the pin 405 or the like.

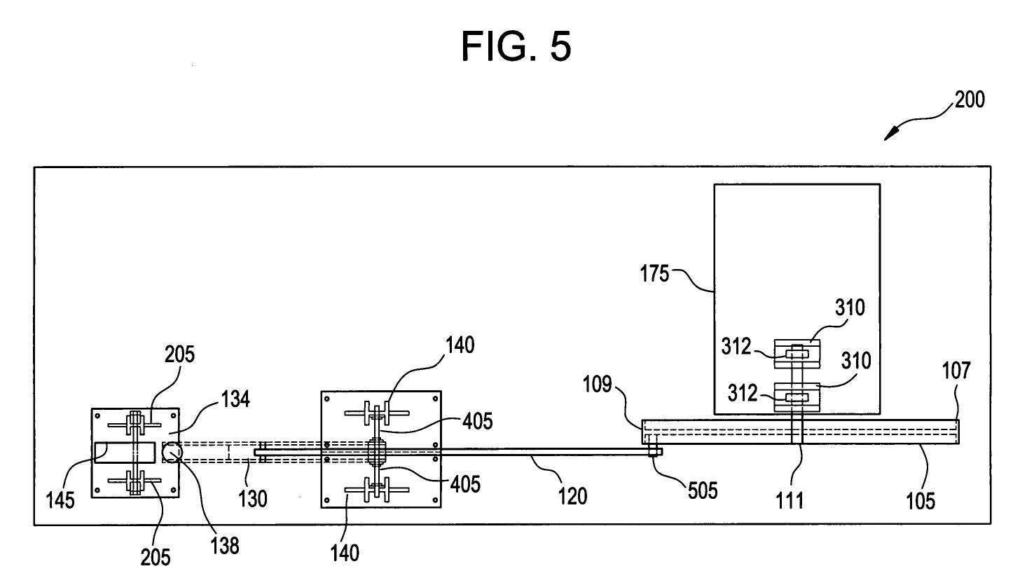

FIG. 5 is a diagram illustrating an overhead view of the system 200 for converting potential energy into electrical energy, in accordance with an exemplary embodiment of the present invention. The system 200 includes the wheel 105 (with periphery 107.and rim 109), the connecting arm 120, the pendulum arm 130, the force producing device 145 and generator 175. The connecting arm 120 couples or otherwise connects the wheel 105 and the pendulum arm 130. According to an exemplary embodiment, the connecting arm 120 is attached to the wheel 105 by, for example, a pin 505 or the like. The wheel 105 turns about the axle 111 that passes through an opening in the center of the wheel 105. The axle 11 attaches the wheel 105 to the mounting structure 310. The mounting structure 310 includes mounting elements 312. The system 200 includes a pendulum arm support 140 and a pin 405 or the like for mounting the pendulum arm 130 to the pendulum arm support 140.

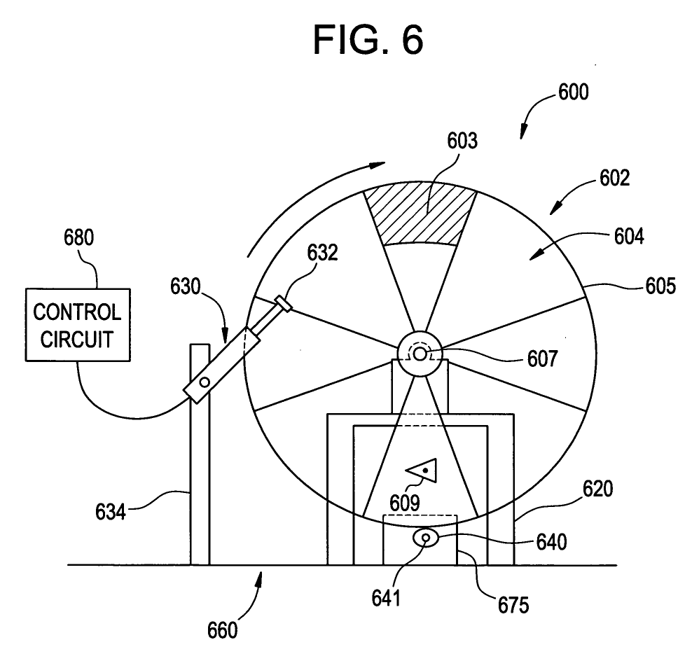

FIG. 6 is a diagram illustrating a system 600 for converting potential energy into electrical energy, in accordance with an alternative exemplary embodiment of the present invention. The system 600 includes a wheel 602 including a periphery 604, a rim 605 and an axle 607 passing through a center of and substantially perpendicular to the wheel 602. The axle 607 can be attached to a wheel support 620. The system 600 includes a counterweight 603 located on the periphery 604 or outer diameter of the wheel 602. The counterweight 603 rotates from a maximum height to a minimum height. The counterweight 603 can be separately attached to the wheel 602 or can be integrally formed with the wheel 602. According to an exemplary embodiment, the wheel 602 can include elements for attaching the counterweight 603. For example, the wheel 602 can include pins or protrusions for mounting the counterweight 603, where the counterweight 603 would include complementary holes or slots for engaging the pins or protrusions on the wheel 602. A plurality of counterweights 603 can be located on the periphery 604 of the wheel 602. For example, multiple counterweights 603 can be stacked on each other and attached to the wheel 602. The multiple counterweights 603 can be located on either or both sides of the wheel 602.

The wheel 602 also includes a force receiving portion 609. According to an exemplary embodiment, the force receiving portion 609 can located on the opposite diameter to the counterweight 603 on the wheel 602. The force receiving portion 609 can be attached to the wheel 602 using any suitable means, or can form an integral element of the wheel 602. According to exemplary embodiments, the force receiving portion 609 can be shaped to receive an impacting force on one side. The force receiving portion 609 can be, for example, a rigid structure or can be sufficiently resilient to receive a large number of impacts over a long period of time and/or be constructed to amplify the force of the impact. Additionally, the force receiving portion 609 can be reinforced or can include a specialized force receiving structure such as a pad, indentation, spring, shield, or the like or any combination thereof.

The system 600 includes a force producing device 630. The force producing device 630 is located proximate to and contacts the force receiving portion 609 of the wheel 602. According to exemplary embodiments, the force receiving portion 609 of the wheel 602 comes into physical contact with a force producing device 630. The force producing device 630 can be mounted on a support 634. The support 634 can be mounted on base 660. According to an alternative exemplary embodiment, the force producing device 630 can be mounted directly on the wheel 602 (e.g., to exert a force against the support 634). The force producing device 630 can include an impacting end 632. The impacting end 632 physically contacts the force receiving portion 609 of the wheel 602. The force producing device 630 can be comprised of any suitable mechanism that is capable of producing a force of a predetermined amount. The force is applied to the force receiving portion 609 to impel the wheel 602. For example, the force producing device 630 can include a piston, a spring actuated device, a water jet, an air compressor, a magnet, a wheel, a pulley, a gear or the like. For example, the force producing device 630 can comprise a pneumatic piston in a preferred embodiment.

The force producing device 630 can also be coupled to a control circuit 680 for controlling activation of the force producing device 630. Based on, for example, the rate of spin of the wheel 602, the control circuit 680 can control the timing of the activation of the impacting end 632 of the force producing device 630 to coincide with the time when the force receiving portion 609 is in the appropriate position to maximize the amount of force applied to the force receiving portion 609 of the wheel 602. The control circuit 680 can be comprised of any suitable digital, analog, or mechanical means that is capable of consistently and reliably activating the force producing device 630 at predetermined times or intervals.

The system 600 includes a rotational force transferring device 640. The rotational force transferring device 640 is in contact with the rim 605 of the wheel 602. The rotational force transferring device 640 is coupled to a generator 675 for generating electricity utilizing the rotational force received from the rotational force transferring device 640. According to exemplary embodiments, the rotational force transferring device 640 can comprise a pinion, a wheel, a gear or the like. The rotational force transferring device 640 can be connected to the generator 675 by an axle 641. Additionally, the rotational force transferring device 640 can include a belt or other drive system for coupling the axle 641 of the rotational force transferring device 640 to the generator 675. The rim 605 of the wheel 602 can include an interactor structure or element for interacting or otherwise engaging the rotational force transferring device 640. According to an exemplary embodiment, the rotational force transferring device 640 can comprise a pinion or gear system, and the interactor structure on the rim 605 of the wheel 602 for interacting with the rotational force transferring device 640 can comprise a plurality of teeth or the like.

According to exemplary embodiments, the wheel 602 can be constructed of any suitably durable substance, such as metal, word, plastic or the like. The weight and diameter of the wheel 602 will depend on, for example, the available space at the area of installation, the size of the counterweight 603 and the desired energy production. For example, the wheel 602 can have a diameter in the range of approximately one meter to approximately ten meters, with the wheel 602 having a diameter of approximately two meters in a preferred embodiment. However, the wheel 602 can be of any suitable diameter.

The axle 607 can be formed of any suitably durable substance, such as metal or plastic. For example, the axle 607 can be formed from a high torsion steel alloy or the like. The diameter and length of the axle 608 will depends on, for example, the size of the wheel 602 and the like. For example, according to an exemplary embodiment, the axle 607 can have a diameter in the range of approximately forty millimeters to approximately one hundred millimeters, with the axle 607 having a diameter of approximately sixty two millimeters in a preferred embodiment. However, the axle 607 can be of any suitable diameter.

The size, weight and shape of the counterweight 603 will depend on, for example, the size of wheel 602. According to an exemplary embodiment, the counterweight 603 can be shaped to minimize air friction as it rotates around the axis of the wheel 602. The weight of the counterweight 603 will depend on, for example, the structure and diameter of the wheel 602, the amount of electrical energy to be produced by the system 600, and the like. According to an exemplary embodiment, the counterweight 603 can weigh in the range of approximately zero kilograms to approximately 500 kilograms. For example, the counterweight 603 can weigh in the range of approximately forty kilograms to approximately two hundred kilograms in a preferred embodiment, although the counterweight 603 can be of any suitable weight. According to an exemplary embodiment, the wheel 602 includes multiple counterweights 603, located on both sides of the wheel 602. For example, the wheel 602 can include two counterweights 603, where each counterweight weighs in the range of approximately forty kilograms to approximately two hundred kilograms.

The rotational force transferring device 640 can be formed of any suitably durable material, so that the mechanism can withstand constant turning. According to an exemplary embodiment, the rotational force transferring device 640 can comprise a metal device coated in rubber or a rubber device.

Thus, according to exemplary embodiment illustrated, for example, in FIG. 6, a counterweight 603 is attached to a wheel 602. The wheel 602 is then mechanically or physically rotated to raise the counterweight 603 to a maximum height. The wheel 602 is then released, allowing the wheel 602 to rotate and the counterweight 603 to descend along the rotational path of the wheel 602 to a minimum height. The potential energy of the counterweight 603 is converted into kinetic energy through the motion of the counterweight 603 and the rotation of the wheel 602. During the rotation of the wheel 602 caused by the descending counterweight 603, a force producing device 630 is activated, providing an impelling force on the wheel 602, through a force receiving portion 609, along the rotational path of the wheel 602. The force producing device 630 provides the impelling force on the wheel 602 while the counterweight 603 is descending rotationally from the maximum height to the minimum height.

The impelling force can be initiated while the counterweight 603 is descending, but before the counterweight reaches the minimum height. The impelling force can continue to affect the rotation of the wheel 602 past the minimum height of the counterweight and into the ascending rotation. The magnitude, timing and length of the impelling force can vary depending on, for example, the size of the wheel 602, the mass of the counterweight 603, the amount of electrical energy that is desired by a user of the system 600, and the like.

The rotational energy of the wheel 602 can then be transferred to a generator 675 by a rotational force transferring device 640. The rotational force transferring device 640 can be mated to a pulley or gear system, that, in turn, transfers the rotational force to the generator 675. The generator 675 converts the rotational energy of the wheel 602 through the rotational force transferring device 640 into electrical energy. According to an exemplary embodiment, a portion of the electrical energy generated by the generator 675 can be rerouted into the system 600 to the force producing device 630. The electrical energy provided by the generator 675 allows the force producing device 630 to consistently provide periodic force to the rotation of the wheel 602. The remaining electrical energy generated by the system 600 can be routed for any industrial, commercial, residential, educational or other like use.

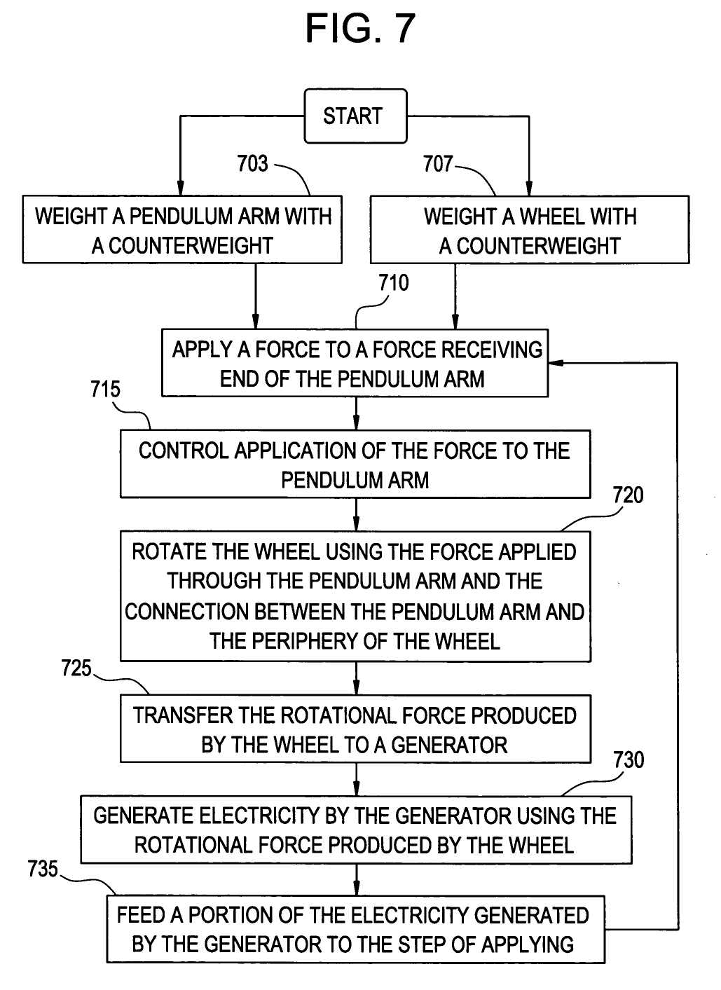

FIG. 7 is a flowchart illustrating steps for converting potential energy into electrical energy, in accordance with an exemplary embodiment of the present invention. According an exemplary embodiment, in step 703, a pendulum arm can be weight with a counterweight. The counterweight can be coupled proximate to the force receiving end of the pendulum arm. According to the exemplary embodiment, at least one magnet can be located proximate to the counterweight at a point of a motion of the pendulum arm. According to an alternative exemplary embodiment, in step 707, a wheel can be weighted with a counterweight. The counterweight can be located on the periphery of the wheel. According to the alternative exemplary embodiment, at least one magnet can be located proximate to the wheel.

In either embodiment, in step 710, a force can be applied to a force receiving end of the pendulum arm. The pendulum arm can be connected to a periphery of a wheel. In step 715, application of the force to the pendulum arm can be controlled. For example, the force can be applied to the pendulum arm at predetermined intervals. In step 720, the wheel can be rotated using the force applied through the pendulum arm and the connection between the pendulum arm and the periphery of the wheel. In step 725, a rotational force produced by the wheel can be transferred to a generator. In step 730, electricity can be generated by the generator using the rotational force produced by the wheel. In step 735, a portion of the electricity generated by the generator can be feed to the step 710 of applying the force.

According to exemplary embodiments, a second force can be applied to a force receiving end of a second pendulum arm of the pendulum. The second pendulum arm can be connected to a periphery of a wheel. The wheel can be rotated using the second force applied through the second pendulum arm and the connection between the second pendulum arm and the periphery of the wheel. In addition, the pendulum arm can be weighted with a first counterweight. The first counterweight can be coupled proximate to the force receiving end of the pendulum arm. The second pendulum arm can be weighted with a second counterweight. The second counterweight can be coupled proximate to the force receiving end of the second pendulum arm.

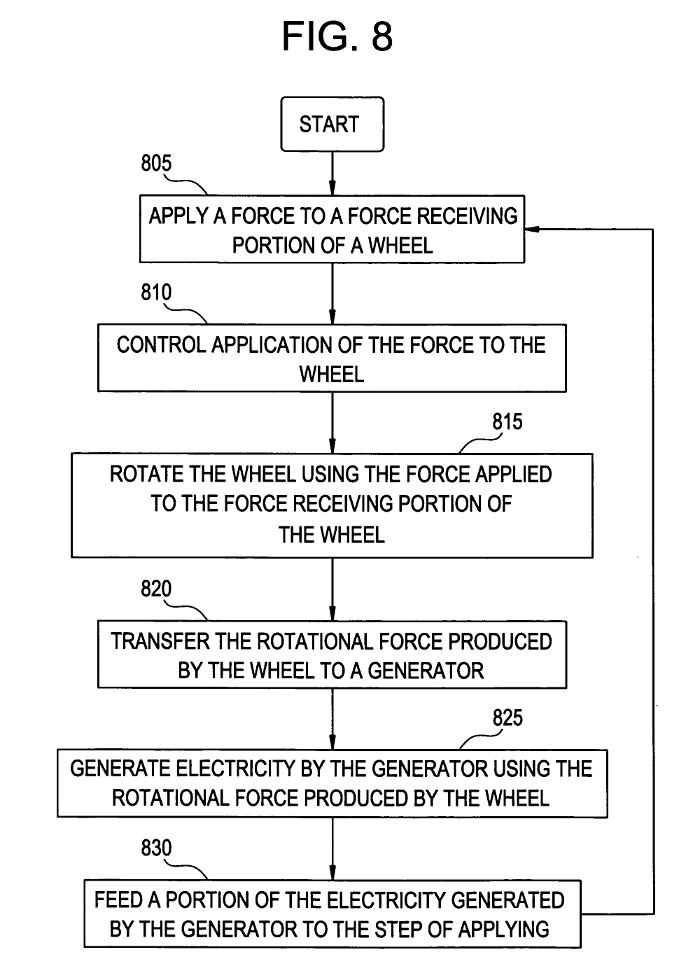

FIG. 8 is a flowchart illustrating steps for converting potential energy into electrical energy, in accordance with an alternative exemplary embodiment of the present invention. In step 805, a force is applied to a force receiving portion of a wheel. In step 810, application of the force to the wheel is controlled. For example, the force can be applied to the wheel at predetermined intervals. In step 815, the wheel can be rotated using the force applied to the force receiving portion of the wheel. In step 820, a rotational force produced by the wheel can be transferred to a generator. In step 825, electricity can be generated by the generator using the rotational force produced by the wheel. In step 830, a portion of the electricity generated by the generator can be feed to the step 805 of applying the force.

Exemplary embodiments of the present invention can be used for producing electrical power in any area of the world where reliable, affordable electrical energy is needed, and with no concomitant industrial pollution. Additionally, exemplary embodiments can be transported and assembled in a number of remote areas inhabited by humans where little or no natural resources are available for fuel. Furthermore, exemplary embodiments of the present invention can be accessible to individuals with limited technical expertise and be available in a range of sizes so that it can be used in areas that lack abundant space.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and applications, foreign patents, and publications discussed above are hereby incorporated herein by reference in their entireties.

1. A system for converting potential energy into electrical energy, comprising:
a wheel,
wherein the wheel includes:
a periphery,
a rim, and
an axle passing through a center of and substantially perpendicular to the wheel,
wherein the axle is attached to a wheel support;
a connecting arm,
wherein the connecting arm includes a wheel end and a connector end,
wherein the wheel end of the connecting arm is coupled to the periphery of the wheel;
a pendulum arm,
wherein the pendulum arm includes:
a support end,
a force receiving end, and
a connector portion,
wherein the support end is coupled to a pendulum arm support, and
wherein the connector portion is coupled to the connector end of the connecting arm;
a force producing device,
wherein the force producing device is located proximate to and contacts the force receiving end of the pendulum arm; and
a rotational force transferring device,
wherein the rotational force transferring device is in contact with the rim of the wheel, and
wherein the rotational force transferring device is coupled to a generator for generating electricity utilizing a rotational force received from the rotational force transferring device.

2. The system of claim 1, comprising:
a counterweight,
wherein the counterweight is coupled proximate to the force receiving end of the pendulum arm.

3. The system of claim 2, comprising:
at least one magnet located proximate to the counterweight at a point of a motion of the pendulum arm.

4. The system of claim 1, comprising:
a counterweight,
wherein the counterweight is located on the periphery of the wheel.

5. The system of claim 4, comprising:
at least one magnet located proximate to the wheel.

6. The system of claim 1, comprising:
a second connecting arm,
wherein the second connecting arm includes a wheel end and a connector end, and
wherein the wheel end of the second connecting arm is coupled to the periphery of the wheel; and
a second pendulum arm,
wherein the second pendulum arm includes:
a support end,
a force receiving end, and
a connector portion,
wherein the support end of the second pendulum arm is coupled to the pendulum arm support, and
wherein the connector portion of the second pendulum arm is coupled to the connector end of the second connecting arm.

7. The system of claim 6, comprising:
a counterweight,
wherein the counterweight is located on the periphery of the wheel.

8. The system of claim 6, comprising:
a second force producing device,
wherein the second force producing device is located proximate to and contacts the force receiving end of the second pendulum arm.

9. The system of claim 6, wherein the force producing device is located proximate to and contacts the force receiving end of the second pendulum arm.

10. The system of claim 6, comprising:
a first counterweight,
wherein the first counterweight is coupled proximate to the force receiving end of the pendulum arm; and
a second counterweight,
wherein the second counterweight is coupled proximate to the force receiving end of the second pendulum arm.

11. The system of claim 1, wherein the force receiving end of the pendulum arm comprises a pad.

12. The system of claim 1, wherein the force producing device comprises a piston.

13. The system of claim 12, wherein the force producing device comprises a pneumatic piston.

14. The system of claim 1, wherein the force producing device is coupled to a control circuit for controlling activation of the force producing device.

15. The system of claim 1, wherein the rotational force transferring device comprises a pinion.

16. The system of claim 15, wherein the rim of the wheel comprises an interactor structure for engaging the pinion.

17. The system of claim 16, wherein the interactor structure comprises a plurality of teeth.

18. The system of claim 1, wherein the rotational force transferring device comprises a belt drive for coupling the rotational force transferring device to the generator.

19. The system of claim 1, wherein a portion of the electricity generated by the generator is utilized by the force producing device.

20. A system for converting potential energy into electrical energy, comprising:
a wheel,
wherein the wheel includes:
a periphery,
a rim, and
an axle passing through a center of and substantially perpendicular to the wheel,
wherein the axle is attached to a wheel support, and
a force receiving portion;
a counterweight located on the periphery of the wheel;
a force producing device,
wherein the force producing device is located proximate to and contacts the force receiving portion of the wheel; and
a rotational force transferring device,
wherein the rotational force transferring device is in contact with the rim of the wheel, and
wherein the rotational force transferring device is coupled to a generator for generating electricity utilizing a rotational force received from the rotational force transferring device.

21. The system of claim 20, wherein the force producing device comprises a piston.

22. The system of claim 20, wherein the force producing device is coupled to a control circuit for controlling activation of the force producing device.

23. The system of claim 20, wherein the rotational force transferring device comprises a pinion.

24. The system of claim 20, wherein a portion of the electricity generated by the generator is utilized by the force producing device.

25. A system for converting potential energy into electrical energy, comprising:
a pendulum arm,
wherein the pendulum arm includes:
a support end,
a force receiving end, and
an interactor portion,
wherein the support end is coupled to a pendulum arm support;
a wheel,
wherein the wheel is oriented substantially perpendicular to the pendulum arm,
wherein the wheel includes:
a periphery,
a rim,
an axle passing through a center of and substantially perpendicular to the wheel,
wherein the axle is attached to a wheel support, and
an interactor structure located on the periphery for engaging the interactor portion of the pendulum arm;
a force producing device,
wherein the force producing device is located proximate to and contacts the force receiving end of the pendulum arm; and
a rotational force transferring device,
wherein the rotational force transferring device is in contact with the rim of the wheel, and
wherein the rotational force transferring device is coupled to a generator for generating electricity utilizing a rotational force received from the rotational force transferring device.

26. The system of claim 25, comprising:
a counterweight,
wherein the counterweight is coupled proximate to the force receiving end of the pendulum arm.

27. The system of claim 26, comprising:
at least one magnet located proximate to the counterweight at a point of a motion of the pendulum arm.

28. The system of claim 25, wherein the force producing device is coupled to a control circuit for controlling activation of the force producing device.

29. A system for converting potential energy into electrical energy, comprising:
rotating means for rotating about an axis,
wherein the axis is coupled to a first support means for supporting the rotating means;
means for generating rotation of the rotating means,
wherein the means for generating rotation comprises a means for receiving force and a connecting means, and
wherein the means for generating rotation is coupled to a second support means for supporting the means for generating rotation;
coupling means for coupling the connecting means of the means for generating rotation to a periphery of the rotating means;
means for producing force,
wherein the means for producing force is located proximate to and contacts the means for receiving force of the means for generating rotation; and
means for transferring rotational force,
wherein the means for transferring rotational force is in contact with the rotating means, and
wherein the means for transferring rotational force is coupled to a means for generating electricity utilizing a rotational force received from the means for transferring rotational force.

30. A system for converting potential energy into electrical energy, comprising:
means for generating rotation,
wherein the means for generating rotation includes a means for engaging and a means for receiving force,
wherein the means for generating is coupled to a first support means for supporting the means for generating rotation;
rotating means for rotating about an axis,
wherein the rotating means is oriented substantially perpendicular to the means for generating rotation,
wherein the rotating means includes interactor means located on a periphery of the rotating means for engaging the means for engaging of the means for generating rotation, and
wherein the axis is coupled to a second support means for supporting the rotating means;
means for producing force,
wherein the means for producing force is located proximate to and contacts the means for receiving force of the means for generating rotation; and
means for transferring rotational force,
wherein the means for transferring rotational force is in contact with the rotating means, and
wherein the means for transferring rotational force is coupled to a means for generating electricity utilizing a rotational force received from the means for transferring rotational force.

31. A method of converting potential energy into electrical energy, comprising the steps of:
applying a force to a force receiving end of a pendulum arm,
wherein the pendulum arm is connected to a periphery of a wheel;
rotating the wheel using the force applied through the pendulum arm and the connection between the pendulum arm and the periphery of the wheel;
transferring a rotational force produced by the wheel to a generator; and
generating electricity by the generator using the rotational force produced by the wheel.
